(19) United States
(12) Patent Application Publication
(10) Pub. No.: US 2007/0184873 A1
(43) Pub. Date: Aug. 9, 2007

(54) Dual-mode phone and power management method thereof

(76) Inventors: Hsien-Tang Li, Tu-Cheng (TW); Shih-Lung Hsu, Tu-Cheng (TW); Chia-Chi Lin, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(21) Appl. No.: 11/647,885

(22) Filed: Dec. 29, 2006

(30) Foreign Application Priority Data
Dec. 30, 2005 (TW) 94147437

(51) Int. Cl. H04M 1/00

(52) U.S. Cl. 455/552.1

(57) ABSTRACT

A dual-mode phone wirelessly communicated with a network device is provided. The dual-mode phone comprises a detecting module, a radio frequency (RF) module, and a processing module. The detecting module is for detecting a setting of the dual-mode phone. The RF module is for establishing connection between the dual-mode phone and the network device. The processing module is for switching on or off the RF module, and for controlling the dual-mode phone to enter or exit a power management mode or a communication mode. A power management method for a dual-mode phone is also provided.

### BACKGROUND OF THE INVENTION

1. Field of the Invention

The invention relates to a phone and power management method thereof, and more particularly to a dual-mode phone and power management method thereof.

2. Description of Related Art

With rapid development of telecommunication technology, a traditional single-mode phone is gradually replaced by a dual-mode phone. The dual-mode phone is capable of selecting among different communication networks according to different requirements and environments. For example, when a user carrying the dual-mode phone is in a network environment with poor signal strength, he or she may switch to another network with a better signal strength to greatly improve communication quality.

One of the problems of a dual-mode phone integrating a global system for mobile communications (GSM) sub-system with a wireless fidelity (WiFi) sub-system is that, the dual-mode phone communicates with a GSM-based base station and a WiFi-based access point simultaneously every microsecond, and a power supply inside the dual-mode phone has to supply power thereto continuously, reducing a standby time thereof accordingly.

Therefore, a heretofore unaddressed need exists in the industry to overcome the aforementioned deficiencies and inadequacies.

### SUMMARY OF THE INVENTION

A dual-mode phone wirelessly communicated with a network device is provided. The dual-mode phone comprises a detecting module, a radio frequency (RF) module, and a processing module. The detecting module is for detecting a setting of the dual-mode phone. The RF module is for establishing a connection between the dual-mode phone and the network device. The processing module is for switching on or off the RF module, and for controlling the dual-mode phone to enter or exit a power management mode or a communication mode.

A power management method for a dual-mode phone is also provided. The power management method includes detecting a setting of the dual-mode phone to determine whether a wireless fidelity (WiFi) function needs to be enabled, switching on an RF module and a plurality of peripheral devices if the WiFi function needs to be enabled, operating in a power management mode, determining whether the dual-mode phone needs to communicate, and switching from the power management mode to a communication mode if there is a need for the dual-mode phone to communicate.

Other advantages and novel features will become more apparent from the following detailed description when taken in conjunction with the accompanying drawings, in which:

### BRIEF DESCRIPTION OF THE DRAWINGS

FIG. 1 is a schematic diagram illustrating an application environment of a dual-mode phone of an exemplary embodiment of the invention;

FIG. 2 is a block diagram of the dual-mode phone of the exemplary embodiment of the invention;

FIG. 3 is a flowchart of a power management method for a dual-mode phone of another exemplary embodiment of the invention;

FIG. 4 is detailed flowchart of step S305 in FIG. 3 of the exemplary embodiment of the invention; and

FIG. 5 is a detailed flowchart of step S309 in FIG. 3 of the exemplary embodiment of the invention.

### DETAILED DESCRIPTION OF THE INVENTION

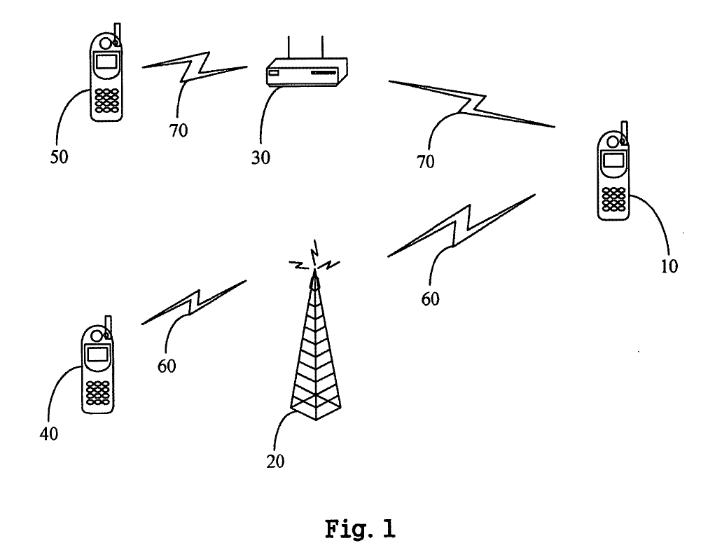

FIG. 1 is a schematic diagram illustrating an application environment of a dual-mode communicating apparatus like a dual-mode phone of an exemplary embodiment of the invention.

The dual-mode phone 10 may either communicate with a terminal 40 via a network device 20 in a first network 60, or with another terminal 50 via an access point 30 in a second network 70. In this embodiment, the first network 60 is a global system for mobile communications (GSM) network, the second network 70 is a wireless fidelity (WiFi) network, the network device 20 is a base station.

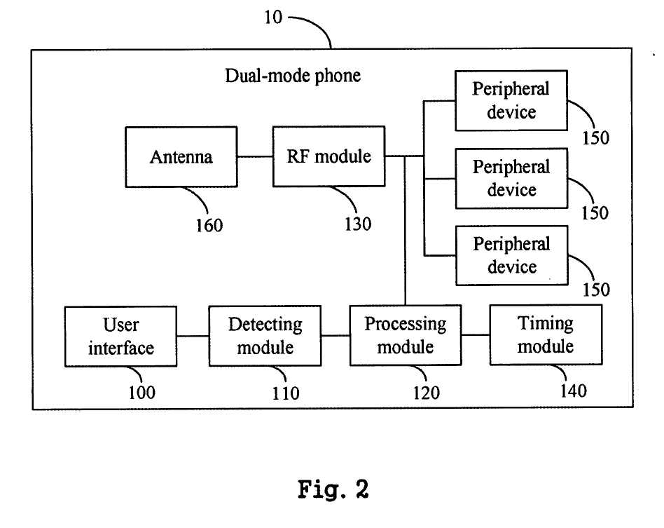

FIG. 2 is a block diagram of the dual-mode phone 10 of the exemplary embodiment of the invention. The dual-mode phone 10 includes a user interface 100, a detecting module 110, a processing module 120, a radio frequency (RF) module 130, a timing module 140, a plurality of peripheral devices 150, and an antenna 160. It should be noted that although only three peripheral devices 150 are illustrated in FIG. 2, the present invention is not limited to that number of peripheral devices.

The user interface 100 provides a man-machine interface (MMI).

The detecting module 110 detects a setting of the dual-mode phone 10 via the user interface 100.

The processing module 120 is communicated with the RF module 130 and the peripheral devices 150, to switch on or off the RF module 130 and the peripheral devices 150, and controls the dual-mode phone 10 to operate in a power management mode or a communication mode.

The RF module 130 establishes a connection between the dual-mode phone 10 and the network device 30.

The timing module 140 is communicated with the processing module 120 to inform the processing module 120 to switch on the RF module 130 within a predetermined timing period. In this embodiment, the predetermined timing period is 500 ms.

The peripheral devices 150 are communicated with the RF module 130, to provide a connection port. In this embodiment, the peripheral devices 150 include devices such as a display, a keypad, a network interface, and so on.

The antenna 160 is communicated with the RF module 130, to transmit a signal thereto and receive a signal from the network device 30.

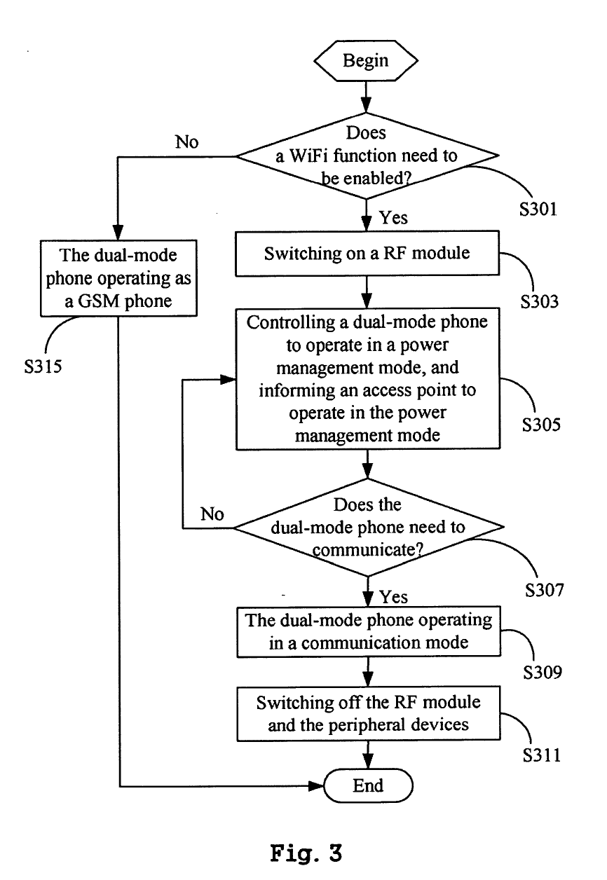

FIG. 3 is a flowchart of a power management method for the dual-mode phone 10 of another exemplary embodiment of the invention.

In step S301, the detecting module 110 detects the setting of the dual-mode phone 10 via the user interface 100, to determine whether the WiFi function needs to be enabled. If the WiFi function needs to be enabled, the process proceeds to step S303. If the WiFi function needs not to be enabled, the process proceeds to step S315.

In step S303, the processing module 120 switches on the RF module 130, and thus, communication between the dual-mode phone 10 and the access point 30 is established.

In step S305, the processing module 120 controls the dual-mode phone 10 to operate in the power management mode, and informs the access point 30 to operate in the power management mode.

In step S307, the detecting module 110 determines whether the dual-mode phone 10 needs to communicate with other terminal devices. If the dual-mode phone 10 needs to communicate with other terminal devices, the process proceeds to step S309.

In step S309, the processing module 120 controls the dual-mode phone 10 to switch from the power management mode to the communication mode.

In step S311, the processing module 120 switches off the RF module 130 and the peripheral devices 150.

If the WiFi function need not be enabled, in step S315, the dual-mode phone 10 operates as a GSM phone.

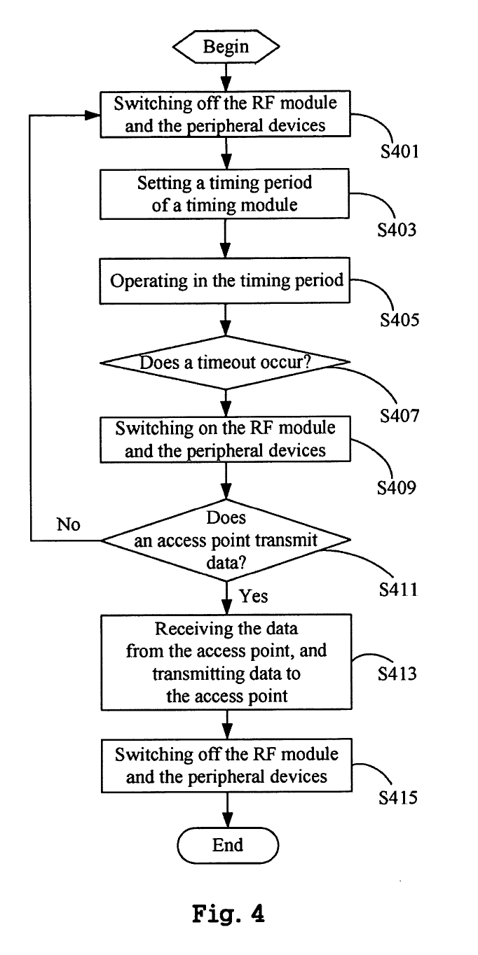

FIG. 4 is a detailed flowchart of step S305 in FIG. 3 of the exemplary embodiment of the invention.

In step S401, the processing module 120 switches off the RF module 130 and the peripheral devices 150.

In step S403, the dual-mode phone 10 sets a timing period of the timing module 140. The timing period of the timing module 140 is set to a delivery traffic indication message (DTIM) period, which is a time period for sending signals to the dual-mode phone 10 by the access point 30.

In step S405, the timing module 140 operates in the timing period.

In step S407, the timing module 140 determines whether a timeout occurs. If the timeout occurs, the process proceeds to step S409. If no timeout occurs, the process returns to step S407.

In step S409, the timing module 140 informs the processing module 120 to switch on the RF module 130 and the peripheral devices 150, in order to receive a beacon packet from the access point 30.

In step S411, the processing module 120 determines whether the access point 30 transmits data according to the beacon packet. If the access point 30 transmits the data, the process proceeds to step S411. If the access point 30 does not transmit the data, the process returns to step S401.

In step S413, the RF module 1216 receives the data from the access point 30 via the antenna 160.

In step S415, the processing module 120 switches off the RF module 130 and the peripheral devices 150.

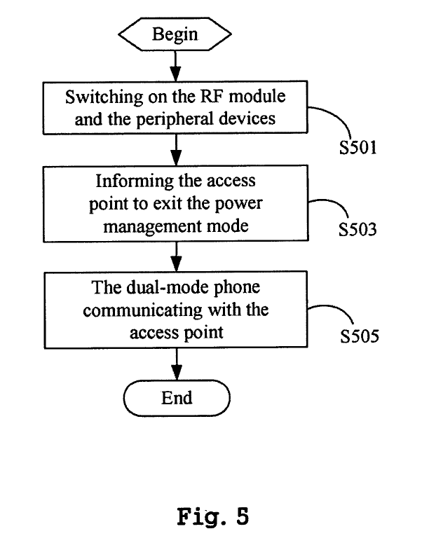

FIG. 5 is a detailed flowchart of step S309 in FIG. 3 of the exemplary embodiment of the invention.

In step 501, the processing module 120 switches on the RF module 130 and the peripheral devices 150.

In step 503, the RF module 130 informs the access point 30 to exit the power management mode.

In step 505, the dual-mode phone 10 communicates with the access point 30.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A dual-mode phone wirelessly communicated with a network device, comprising:
a detecting module for detecting a setting of the dual-mode phone;
a radio frequency (RF) module for establishing connection between the dual-mode phone and the network device; and
a processing module for switching on or off the RF module, and controlling the dual-mode phone to enter or exit a power management mode or a communication mode.

2. The dual-mode phone as recited in claim 1, further comprising a user interface for providing a man-machine interface (MMI).

3. The dual-mode phone as recited in claim 2, further comprising a timing module communicated with the processing module, for informing the processing module to switch on the RF module within a predetermined timing period.

4. The dual-mode phone as recited in claim 3, further comprising a plurality of peripheral devices communicated with the RF module, for providing a connection port.

5. The dual-mode phone as recited in claim 4, further comprising an antenna communicated with the RF module, for receiving a signal from the network device, and for transmitting a signal to the RF module.

6. The dual-mode phone as recited in claim 1, wherein the dual-mode phone is communicated with the network device via a first network or a second network.

7. The dual-mode phone as recited in claim 6, wherein the network device is an access point.

8. The dual-mode phone as recited in claim 7, wherein the first network is a wireless fidelity (WiFi) network.

9. The dual-mode phone as recited in claim 8, wherein the second network is a Global System for Communications (GSM) network.

10. A power management method for a dual-mode phone communicated with a network device, comprising:
detecting a setting of the dual-mode phone to determine whether a wireless fidelity (WiFi) function needs to be enabled;
switching on a RF module and a plurality of peripheral devices if the WiFi function needs to be enabled in a first network;
operating in a power management mode;
determining whether the dual-mode phone needs to communicate with the network device; and
switching from the power management mode to a communication mode if there is a need for the dual-mode phone to communicate with the network device.

11. The power management method as recited in claim 9, further comprising connecting the dual-mode phone to the network device via a second network if the WiFi function need not be enabled.

12. The power management method as recited in claim 11, wherein the second network is a global system for mobile communications (GSM).

13. The power management method as recited in claim 10, wherein operating in the power management mode comprises:
switching off the RF module and the plurality of peripheral devices;
setting a timing period of a timing module;
operating in the timing period;
determining whether a timeout occurs;
switching on the RF module and the plurality of peripheral devices to receive a beacon packet from the network device, if the timeout occurs;
determining whether the network device transmits data according to the beacon packet;
receiving the data if the network device transmits the data; and
switching off the RF module and the plurality of peripheral devices after receiving the data.

14. The power management method as recited in claim 13, wherein the step of operating in the power management mode further comprises switching off the RF module and the plurality of peripheral devices if the network device does not transmit the data.

15. The power management method as recited in claim 10, wherein switching from the power management mode to a communication mode if the dual-mode phone needs to communicate with the network device comprises:
switching on the RF module and the plurality of peripheral devices;
informing the network device to exit the power management mode; and
communicating with the network device by the dual-mode phone.

16. The power management method as recited in claim 10, further comprising informing the network device to operate in the power management mode after connection between the dual-mode phone and the network device is finished.

17. The power management method as recited in claim 10, further comprising switching off the RF module and the plurality of peripheral devices.

18. The power management method as recited in claim 10, wherein the first network is a WiFi network.

19. The power management method as recited in claim 10, wherein the network device is an access point.

20. A method for managing power of a dual-mode communicating apparatus communicable through at least two networks, comprising:
operating a dual-mode communicating apparatus, communicable through a first network and a second network respectively, via said first network when communication of said communicating apparatus through said second network is unnecessary according to predetermined settings of said communicating apparatus;
operating said communicating apparatus via said second network when said communication through said second network is necessary according to said settings of said communicating apparatus;
switching on corresponding modules and devices of said communicating apparatus to be communicable through said second network;
controlling said communicating apparatus in a power management mode, in which said corresponding modules and devices are mainly switched off to save power of said communicating apparatus and are switched on periodically to temporarily establish said communication through said second network, when communication with other terminals of said second network is not available; and
controlling said communicating apparatus in a communication mode, in which said corresponding modules and devices are switched on to maintain said communication through said second network, by means of switching from said power management mode to said communication mode when said communication with said other terminals of said second network is available.
